(19) United States
(12) Patent Application Publication
(10) Pub. No.: US 2008/0223421 A1
(43) Pub. Date: Sep. 18, 2008

(54) Dishwasher and Method for Production Thereof

(75) Inventors: Michael Rosenbauer, Reimlingen (DE); Bernd Schessl, Dillingen/Donau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosh und Siemens Hausgeräte GmbH, Munich (DE)

(21) Appl. No.: 11/793,106

(22) PCT Filed: Oct. 20, 2005
(86) PCT No.: PCT/EP05/55407

§ 371 Date: Jun. 15, 2007

(30) Foreign Application Priority Data
Dec. 17, 2004 (DE) 10 2004 060 946.2

(51) Int. Cl. B08B 3/00; A47L 15/42

(52) U.S. Cl. 134/57 D; 264/261; 134/183

(57) ABSTRACT

A dishwasher includes a washing container provided with a washing tub and a housing cover which is connected to the washing tub. The washing tub is provided with an inner tub and a plastic support in order to reduce the noise occurring when the washing liquid comes into contact with the washing tub.

This invention relates to a dishwasher with a washing container provided with a washing tub and a housing cover which is connected to said washing tub. The invention also relates to a method for producing a dishwasher according to the invention.

Dishwashers normally contain, within an outer frame or housing, a number of operating means which generate undesirable noises during the operation of the appliance. In particular, motors in dishwashers, e.g. for operating a pump, generate noises which have relatively low frequencies ranging from approximately 200 to 300 Hz. These exert a particularly disturbing effect on the area surrounding the household appliance. Frequencies in the range mentioned are difficult to eliminate by means of conventional acoustically absorbing or sound absorbing systems.

During the operation of a dishwasher noises are also generated by the water escaping from the spray arms, which partially comes into contact with the items to be washed arranged in the dishwasher, and partially with the walls of the washing container. Since the cleaning action of a dishwasher improves the more pressure water can exert on the items to be washed, the operating noise generated by a dishwasher is simultaneously increased thereby.

There is therefore a requirement for an effective reduction in the noise level during the operation of dishwashers. A multiplicity of solutions has been proposed in the past for reducing the noise generation or noise emission.

For example, DE 196 03 710 A1 discloses a tumble drier and a drum washing machine in which the jacket of the liquor container is provided with stampings to minimise the generation of noise. This is intended to reduce the noise development during the washing and spinning process and hence the acoustic radiation from the machine housing. Here the noise development is already combated at the point of generation. This procedure, designed for a washing machine, cannot however be transferred easily to dishwashers. For in washing machines the vibrations emanating from the liquor container are transferred when the washing drum rotates on the machine housing. There they are amplified by resonance effects so that the noises radiated from the machine housing to the surrounding area may be disturbing. However, the noise development in a dishwasher is not caused by the rotation of a comparatively heavy component relative to the housing but by water jets coming into contact with the washing container walls, water jets which are not normally observed in a washing machine.

In order to reduce the noise radiation in household appliances equipped with a drive motor DE 82 26 335 U1 proposes providing lateral walls for the purpose of stiffening the stampings. Here the stampings will be embossed and are directed outwards relative to the interior of the housing, several embossed stampings being arranged so that they are uniformly distributed over the entire surface of each lateral wall. The purpose of this procedure is to reduce the flat areas of the lateral walls and simultaneously increase the stiffness of the appliance housing. The multiplicity of embossed stampings is associated with a high degree of stiffness of the lateral walls, as a result of which the wall thickness can be suitably reduced. Since the drive motors of a water-conducting household appliance are generally operated to admit and pump off the washing liquid, the proposed noise damping only acts for very short times throughout an entire operating process. However, since the circulation of the washing liquid and the loading of the items to be washed with the pronounced negative actions occupies a significantly higher proportion of the entire washing programme, the proposed measure for noise damping can contribute only very little.

A dishwasher with a washing container which has inner walls designed to damp noise generated by the spray jets of the spray device is disclosed in DE 23 47 252 A1. For this purpose the inner walls are of corrugated design or are provided with stamped concave and/or convex caps. This has the effect of deflecting the striking spray jets and therefore damping the noise development. In another design the washing container has inner walls which damp the noise from the spray jets of the spray devices and are arranged as intermediate walls in front of the inner washing container walls by means of elastic sealing rings, thereby preventing the spray jets of the spray devices from striking undamped against the washing container with high noise development. Although the proposed measures are able to damp the noise development effectively, it is difficult to produce such a dishwasher because the washing container, or more precisely the housing jacket, is manufactured in one piece for production reasons. The insertion of the structural elements in the inner washing container walls and their subsequent shaping into a housing material therefore requires extraordinarily complex production tools. Consequently the condition for simple production can hardly be met.

To reduce the noise radiation over the housing cover of a household appliance, DE 43 42 102 A1 proposes to provide this cover with stabilising stamping in order to increase its stability. In this case the cover may be produced from sandwich plate providing insulation from structure-borne noise. In practice it has turned out, however, that only a small proportion of the noise development can be influenced by the design of the housing cover, thus the proposed method cannot contribute meaningfully to significant noise insulation.

In order to reduce the noise emission of a dishwasher DE 103 47 244 A1 proposes that it be surrounded by an acoustic insulation in which cooling air ducts are simultaneously installed. In this case the acoustic insulation is arranged between the washing container and an outer wall.

Similarly, DE 20 16 637 discloses a dishwasher with a self-supporting, noise damped washing container. In this container a sheet of cardboard is inserted between the washing container and an outer wall and is fixedly connected to the latter. The damping of structure-borne noise is achieved due to the stiffening of the housing.

It has also already been proposed to provide insulation on the back of the appliance. For instance, according to EP 0 561 201 B1 the rear wall should be formed as a plastic sheet with a cavity so that further material can be inserted in it for acoustic insulation. This application is intended primarily for washing machines in which the liquor container is secured to the rear wall and essential components, particularly the drive elements, are arranged on the rear side.

Independently of specific proposals for achieving a reduction in noise in dishwashers, there is a multiplicity of proposals for general material configurations aimed at reducing noise.

For example, DE 101 22 617 C1 discloses a silencer slide for ventilation engineering in which a profiled metal plate is arranged in front of a filling of a sound absorbing material. DE 43 11 978 C1 describes a composite of dimpled material strips, layered one above the other, with inserted secondary materials. This provides a sound-absorbent, reflecting and strength-increasing property. Curve-structured plates and foils are also generally disclosed as semi-finished products for sound engineering (DE 44 37 986 A1).

WO 99/32703 discloses liquor containers of a water-conducting domestic appliance which is provided, at least in certain regions, with a planar formed, stamped structure.

Although proposals have been made to improve the noise development during operation of a dishwasher, there is an urgent requirement to make further improvements in terms of an optimised noise radiation and emission.

The object of this invention is therefore to reduce the noise development in a dishwasher.

This object is achieved with a dishwasher having the features of claims 1 and 11, and a method for producing the dishwasher according to the invention with the features of claim 16. Advantageous designs of the invention can be found in each of the dependent claims.

The invention is based on the knowledge that a significant proportion of the noise development is caused by the contact of the washing liquid with the washing tub which serves to collect the circulated washing liquid. The washing liquid circulated during operation in a household appliance drips directly or indirectly onto the washing tub after contacting the items to be washed due to the effect of gravity, giving rise interfering sound waves propagating through the housing of the household appliance.

The invention therefore proposes a dishwasher with a washing container which has a washing tub and a housing jacket connected to it. According to the invention the washing tub has an inner tub and a support, in particular a plastic support, and the support is designed so that it effects a noise reduction the washing liquid comes into contact with the washing tub. The support may consist of any material, e.g. metal or plastic, and is normally arranged underneath the inner tub. The strength of the washing tub is increased by a connection between the support and the inner container. As in the proposed procedures of prior art, the reduction of the sound development is based on increasing the strength of a component, in this case the washing tub, thereby reducing the radiation of noises.

In a suitable design of the invention the washing container is constructed in at least two parts, the washing tub forming a first part and the housing jacket a second part. Production is therefore simplified because the tub can be manufactured independently of the jacket or of parts of the housing jacket. In a suitable design the washing tub has a dimensionally stable inner tub, e.g. of a high grade steel, in which structural elements are installed for additional noise reduction.

In a further design the washing tub may also have a dimensionally stable plastic support which may be designed optionally with or without structural elements, the plastic support being fixedly connected to the inner tub. The positive connection between the inner tub and the plastic part can be made by a glued joint, a clamp connection or spring connection, by riveting or thermo-riveting or any other suitable connection method. Although even a washing tub consisting of a dimensionally stable inner tub enables the noise to be reduced during operation of the household appliance, a further improvement can be achieved by connecting the inner wall to the plastic support, since such a connection increases the strength of the washing tub. The inner tub and the plastic support may be prefabricated in a “sandwich” design as a semi-finished product and connected in a later processing step to the prefabricated housing jacket to form a washing container. The sandwich design comprising the inner tub and the plastic support, which consist of different materials, increases the stability of the washing tub and prevents excess propagation of the sound waves and their transmission to the housing jacket, and finally to the outer housing of the appliance.

The structural elements in the dimensionally stable inner tub for further noise reduction may generally be of any nature. In particular, all possibilities known and described from the state of the art may be used. For production reasons it is advantageous for the structural elements to be designed as honeycomb or polygonally structured stiffening patterns.

It is also conceivable to design the structural elements uniformly and/or regularly, with a cross-section that is almost in the shape of a circle segment, or also in the form of caps. Structural elements produced in this manner can be manufactured extremely easily in a press tool.

The structural elements may be designed optionally so that they point inwards or outwards related to the washing space of a completed household appliance.

If the inner tub is connected to a plastic support having structural elements the (optional) structural elements can be formed from a multiplicity of bridges which, in elevation, each enclose a polygon. According to the intersection of the bridges the polygon may be designed as a triangle, a square or rectangle, for example.

On the one hand the provision of bridges increases the stability of the plastic support. On the other hand, air spaces enclosed by the bridges of each polygon and an inner wall section may be formed after the inner tub is placed on the plastic support. Because of the poor sound transmission of air compared to a solid material, a reliable sound transmission and hence noise reduction are achieved.

In a dishwasher according to the invention with a washing container which has a washing tub and a housing jacket connected to it, the washing tub is provided, at least in part, with structural elements, Because of the formation of structural elements in the washing tub the noise development can be reduced by increasing stiffness.

The structural elements are preferably arranged on the inside of the washing tub, which gives the user of the dishwasher an optically better impression because the bottom of the washing container has visible structural elements and the noise development is additionally reduced.

In a further embodiment the structural elements are conditioned by a variable thickness of the washing tub, for example an inner tub, e.g. by a surface of the washing tub on the inside with partial areas having a different inclination or height. Furthermore, the structural elements in the washing tub may also be conditioned by stamping (forming) with the same, constant thickness of the washing tub.

In a supplementary embodiment the structural elements are designed as stiffening patterns having a honeycomb or polygonal structure.

The structural elements are advantageously of the same type and/or regular, with a cross-section almost in the shape of a circle segment.

A method according to the invention for producing a dishwasher has the following steps: Supply of a metallic material whose dimensions have been selected for producing exclusively the washing tub of the dishwasher; and forming of the material into an inner tub of the washing tub, where structural elements are inserted, at least in the bottom region of the inner tub, in the forming step, which elements stiffen the inner tub because of a dimpled structure formed uniformly and/or regularly, where a plastic support having a base support is provided which is adapted to the shaped of the formed inner tub, and where the inner tub, after the forming step, is fixedly connected to the plastic support to form a semi-finished product. The method of producing the positive connection may in this case be based on the possibility that appears most favourable to the person skilled in the art. Glued joints, clamp connections, riveted joints and the production of thermo-riveted joints are generally ideal for this purpose. Here the plastic support is provided with pin-shaped projections which are initially inserted in recesses of the formed inner tub, then formed by heat into spherical heads. It is also possible for the plastic support to bear with pre-tension against the inner tub, thereby making the connection required for transmitting forces.

The step of forming and inserting the structural elements in the metal semi-finished product, is preferably carried out using a press tool with a suitably shaped die.

The plastic support is preferably produced by an injection moulding process in which structural elements can be formed on the base support by the injection moulding tool used. The arrangement and shape of the structural elements which are fastened to the base support, or are integrated in it, may be achieved particularly easily in this manner.

In summary the invention may be seen in the fact that a reduction in the noise development of a dishwasher can be effected by increasing the stiffness of the washing tub. To enable this to be achieved, from the production point of view, the washing container of the household appliance is preferably constructed in two parts, the washing tub being formed separately from a housing jacket. There are several possibilities for designing the washing tub.

The invention is described in detail in the following with reference to the figures, where:

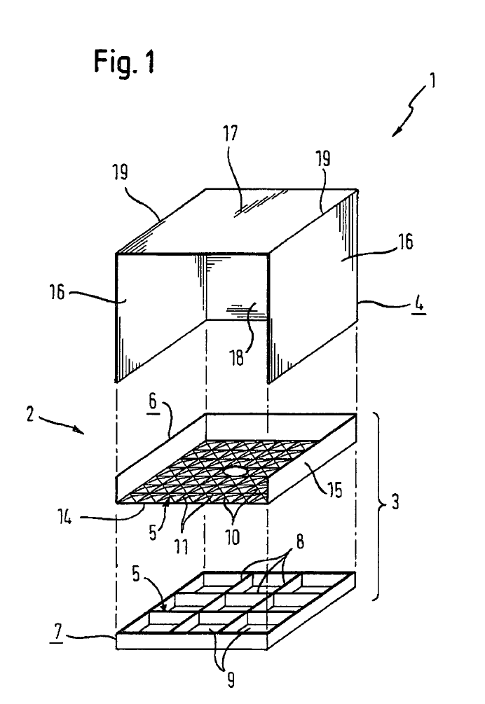

FIG. 1 shows in an exploded representation components of the washing container of a dishwasher according to the invention,

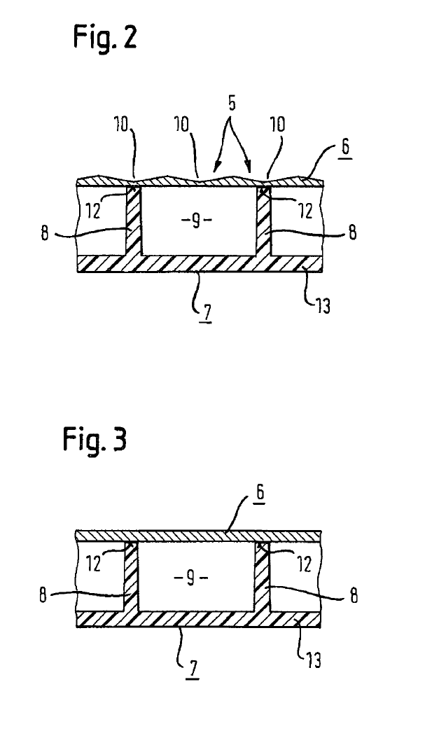

FIG. 2 shows a section of a first exemplary embodiment of a washing tub designed according to the invention, and

FIG. 3 shows a section of a second exemplary embodiment of a washing tub designed according to the invention.

FIG. 1 shows, in an exploded representation, a washing container 2 of a dishwasher 1. Washing container 2 comprises essentially a housing jacket 4 and a washing tub 3. The remaining components of a dishwasher, e.g. the outer housing, motors, pumps, pipes of the washing liquid circuit etc. are not shown for the sake of simplicity. Housing jacket 4 may, for example, be constructed in two parts. Whilst lateral walls 16 and housing roof 17 are designed in one piece, and are formed into their shape shown in the figure by suitable bending along the housing edges 19, rear wall 18 may be connected to the said components to form a housing jacket 4, e.g. by means of a welded joint.

For the purpose of a further noise reduction the lateral walls of the housing jacket can be provided with stampings, recesses, elevations or generally with curvatures or dimples in order to disperse water jets that come into contact with the lateral walls and reduce their noisy action. Furthermore, insulating materials, e.g. of bitumen, can be applied by a known method to the outer sides, i.e. the sides facing away from the interior of the container.

Effective noise reduction can be achieved by providing washing tub 3 with these stiffening structural elements 5. FIG. 1 shows a design of a washing tub 3 according to the invention, which tub is constructed in two parts from a dimensionally stable inner tub 6 and a plastic support 7. Whilst inner tub 6 is produced from a metal material, preferably a stainless high grade steel, plastic support 7 consists of a plastic material that can be injection moulded. Structural elements 5 in the dimensionally stable inner tub 6 are preferably arranged in a bottom region 14 and designed in the shape of curvatures and recesses 10. The high wall regions 15 of the dimensionally stable inner tub 6, shown in an exaggerated manner in FIG. 1, serve primarily to connect the same to housing jacket 4. These components may be connected in principle by any means as long as it is ensured that reliable tightness is provided and the occurrence of crevice corrosion in the transitional region is avoided. The entire washing container 2 rests on a base part, particularly of plastic (not shown). The plastic support, combined with this base part, may be of any design. Plastic support 7 may, for example, be a part of this base part or may represent a separate component which is connected to the base part.

The design of structural elements 5 increasing stiffness is in principle of any nature, stiffening patterns of a honeycomb, polygonal or circular structure having proved advantageous from the production point of view. Recesses 10, which can be arranged on the inside of the washing space or on the outside, related to the washing space, are separated from each other by edge sections 11. During a cleaning programme these divide washing liquid dripping from the items to be washed arranged inside the washing container, and deflect them in different directions, thereby reducing the noise development.

To increase the stiffness of washing tub 3 plastic support 7 is also provided with structural elements 8 in the form of intersecting bridges 8. Because of the regular arrangement of bridges 8 an enclosed air space 9, which also contributes to the noise insulation, is produced after the dimensionally stable inner tub 6 is placed on support surfaces 12 of appropriate bridges 8 (FIGS. 2 and 3).

FIGS. 2 and 3 show two different exemplary embodiments of washing tubs 3 according to the invention. Whilst in FIG. 2 the washing tub is provided with structural elements 5, 8 in the manner described above, inner tub 6 in the exemplary embodiment shown in FIG. 3 has a smooth surface. Connecting a dimensionally stable inner tub 6 provided with a smooth surface to a plastic support 7 provided with structural elements 8 provides a sufficient increase in stiffness to effect a reduction in noise development.

### LIST OF REFERENCE NUMBERS

1 Dishwasher
2 Washing container
3 Washing tub
4 Housing jacket
5 Structural element
6 Inner tub
7 Plastic support
8 Bridge
9 Air space
10 Recess
11 Edge section
12 Contact surface
13 Base support
14 Bottom region
15 Wall region
16 Lateral wall
17 Housing roof
18 Rear wall
19 Edge

1-18. (canceled)

19. A dishwasher comprising:
a door movable between a closed position in which the door closes a door access opening and an open position in which access is available via the door access opening; and
a washing container formed of a washing tub and a housing jacket connected to the washing tub in a watertight manner, the washing container having a door access opening and the door being movable between its closed position in which the door closes the door access opening such that the door, the washing tub, and the housing jacket form a watertight volume into which washing liquid can be introduced for washing items disposed in the watertight volume, and its open position in which access is available via the door access opening, the washing tub having an inner tub and a support configured in correspondence with the inner tub for a supporting engagement of the inner tub by the support, and the support being configured to promote the suppression of noise generated by contact of washing liquid with the washing tub.

20. The dishwasher according to claim 19, wherein the washing container is constructed of at least two parts, wherein the washing tub forms a first part and the housing jacket forms a second part.

21. The dishwasher according to claim 19, wherein the washing tub has a dimensionally stable inner tub configured in a selected one of a configuration with structural elements and a configuration without structural elements.

22. The dishwasher according to claim 21, wherein the washing tub has a dimensionally stable plastic support, configured in a selected one of a configuration with structural elements and a configuration without structural elements, to which the inner tub is fixedly connected by at least one of gluing, riveting, clamping, and another connection means.

23. The dishwasher according to claim 22, wherein the structural elements are designed as stiffening patterns having a selected one of a honeycomb structure and a polygonal structure.

24. The dishwasher according to claim 21, wherein the structural elements are designed uniformly with a cross-section that is approximately the shape of a circle segment.

25. The dishwasher according to claim 21, wherein the structural elements are directed in a selected one of inwards and outwards in relation to the washing volume of the dishwasher.

26. The dishwasher according to claim 22, wherein the structural elements formed in the plastic support are formed by a multiplicity of bridges which each enclose a polygon in elevation.

27. The dishwasher according to claim 26, wherein an air space, enclosed by the bridges of any polygon and an inner tub section, is formed after the inner tub is placed on the plastic support.

28. The dishwasher according to claim 19, wherein the washing tub has a dimensionally stable inner tub and the inner tub and the support are prefabricated as a semi-finished product before a connection is made to the housing jacket to form a washing container.

29. The dishwasher according to claim 19, wherein the washing tub is provided, at least in part, with structural elements.

30. The dishwasher according to claim 29, wherein the structural elements are arranged on the inside of the washing tub.

31. The dishwasher according to claim 29, wherein the structural elements are conditioned by a variable thickness of the washing tub, for example an inner tub, e.g. are conditioned by a surface of the washing tub on the inside with partial surfaces having a variable inclination or by a stamping with the same thickness of the washing tub.

32. The dishwasher according to claim 29, wherein the structural elements are designed as stiffening patterns having a selected one of a honeycomb structure and a polygonal structure.

33. The dishwasher according to claim 29, wherein the structural elements are designed uniformly with a cross-section that is approximately the shape of a circle segment.

34. A method for producing a dishwasher having a door movable to close a door access opening such that the door and a washing container formed of a washing tub and a housing jacket together form a watertight volume into which washing liquid can be introduced for washing items disposed in the watertight volume, the method comprising:
forming an inner tub of the washing tub with a metal material;
disposing a plurality of structural elements in a bottom region of the inner tub, the structural elements imparting a stiffening property to the inner tub and being formed of a selected one of dimpled configurations and non-dimpled configurations; and
following the step of disposing a plurality of structural elements in a bottom region of the inner tub, connecting a support configured in correspondence with the inner tub to form thereby a semi-finished product.

35. The method according to claim 34, wherein the step of disposing a plurality of structural elements in a bottom region of the inner tub is carried out using a press tool with a suitably shaped die.

36. The method according to claim 34, wherein the step of connecting a support includes connecting a support formed as a plastic support by means of an injection molding process, wherein structural elements are formed on the base support with the injection molding tool used.
